(19) United States
(12) Patent Application Publication
(10) Pub. No.: US 2009/0235733 A1
(43) Pub. Date: Sep. 24, 2009

(54) METAL DISK DISCRIMINATION APPARATUS

(75) Inventors: Takehiro Hato, Nakahara-ku (JP); Toshikatsu Akiba, Kisarazu-shi (JP); Kazumi Kotani, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/361,706

(22) Filed: Jan. 29, 2009

(30) Foreign Application Priority Data
Mar. 18, 2008 (JP) 2008-069706

(51) Int. Cl. G07D 5/08

(52) U.S. Cl. 73/163

(57) ABSTRACT

According to one aspect of the invention, there is provided a metal disk discrimination apparatus including: two magnetic sensors configured to sandwich a target metal disk, the magnetic sensor including: a core having: leg portions exhibiting opposite magnetic polarities, the leg portion having an end face facing the target metal disk, and a connection portion magnetically connecting the leg portions; and coils respectively wound on the leg portions; an oscillation circuit that passes an alternating current through the coil; and a signal processing unit that determines a shape of the target metal disk by comparing an output signal of the magnetic sensors with a reference value, the output signal corresponding to a change in impedance of the coils. A radius of curvature of the end face in a part adjacent to another end face is not larger than a radius of the target metal disk.

The entire disclosure of Japanese Patent Application No. 2008-069706 filed on Mar. 18, 2008, including specification, claims, drawings and abstract is incorporated herein by reference in its entirety.

### BACKGROUND

1. Field of the Invention

One aspect of the present invention relates to a discrimination apparatus which discriminates between genuineness and counterfeit, kinds, etc. of metal disks such as coins. Particularly, it relates to a discrimination apparatus which is improved in sensitivity and accuracy for detecting a surface shape or an edge of each metal disk.

2. Description of the Related Art

A coin change machine, an automatic vending machine or the like in a point of sales (POS) registration system is equipped with a coin discrimination apparatus which discriminates between genuineness and counterfeit of inserted coins and discriminates between kinds of the coins. Besides the coins, metal disks such as medals used in a game arcade or the like may need to be discriminated in the same manner as the coins.

Magnetic sensors using coils and cores are used as mainstream sensors used for discriminating coins in a coin change machine, an automatic vending machine, etc. Kinds of magnetic sensors are used for detecting materials, outer diameters, thicknesses, etc. of coins so that discrimination is performed based on these pieces of information. In the magnetic sensors, the coils are excited to emit magnetic flux so that discrimination is performed based on the difference between electrical characteristics which appear in sensor signals when coins pass through the magnetic flux.

Some coins however have similar shapes because a wide variety of coins are issued as currencies from countries of the world. In addition, there are some people who counterfeit coins of foreign countries and try to use the counterfeit coins illegally. From such a background, there is a demand for detection of characteristics of coins with higher sensitivity and higher accuracy.

In order to grasp characteristics of coins more accurately, it is necessary to detect minute shapes such as surface patterns of the coins. From these facts, there has been a demand for sensors for particularly detecting surface shapes or edges of coins with higher sensitivity and higher accuracy.

To satisfy this demand, for example, there is known an apparatus disclosed in JP-B-3891101. This apparatus has a pair of two-legged magnetic sensors: one sensor is disposed along one side of a coin passageway so that respective end faces of the legs become parallel to a central surface of the coin passageway; and the other sensor is disposed on the opposite side of the coin passageway so as to be symmetrical to the one sensor with interposition of the coin passageway. In each two-legged magnetic sensor, the end face of each leg is shaped like a rectangle. The pair of two-legged magnetic sensors are disposed so that long sides of each rectangle are perpendicular to the direction of movement of a coin, and that the long sides facing each other are arranged at a distance so as to be parallel to each other. Coils are excited so that the two legs of each sensor emit magnetic fluxes with opposite magnetic polarities whereas magnetic pole surfaces facing each other with interposition of the coin passageway have the same polarity. As a result, the magnetic fluxes are refluxed between the two legs so that the magnitude of leakage magnetic flux emitted from other places than the long sides can be ignored compared with the magnitude of principal magnetic flux flowing between the long sides. In this manner, a coin discrimination apparatus is configured.

In the aforementioned background art, there may be however a problem as follows. Although shaping each end face of the two-legged core like a rectangle results in reducing leakage magnetic flux, it is difficult to detect the surface shape of a coin with high accuracy because when the surface shape of a coin is to be detected, the surface shape is detected in a range affected by magnetic flux emitted from the length (width) of each long side, so that an average of the shape in a certain range is output as a sensor output.

### SUMMARY

According to one aspect of the invention, there is provided a metal disk discrimination apparatus including: two magnetic sensors configured to sandwich a target metal disk and disposed in positions symmetrical to each other with respect to the target metal disk, each of the two magnetic sensors including: a two-legged core having: two leg portions disposed opposing to a face of the target metal disk with an interval between the two leg portions along a movement direction, the movement direction in which the two magnetic sensors move relatively with respect to the target metal disk along a direction parallel to faces of the target metal disk, the two leg portions exhibiting magnetic polarities opposite to each other, each of the two leg portions having an end face facing the target metal disk, and a connection portion disposed distant from the target metal disk and magnetically connecting the two leg portions; and two coils respectively wound on the two leg portions; an oscillation circuit configured to pass an alternating current through each of the two coils; and a signal processing unit configured to determine a shape of the target metal disk by comparing an output signal of the two magnetic sensors with a reference value, the output signal corresponding to a change in impedance of the coils generated due to presence of the target metal disk; wherein: the leg portions of one of the two magnetic sensors have same polarities as the corresponding leg portions of the other of the two magnetic sensors; and a radius of curvature of the end face in a part adjacent to another end face is not larger than a radius of the target metal disk.

### BRIEF DESCRIPTION OF THE DRAWINGS

Embodiment may be described in detail with reference to the accompanying drawings, in which:

FIG. 1 is an exemplary perspective view showing an embodiment of a metal disk discrimination apparatus according to the invention;

FIG. 2 is an exemplary plan view of the metal disk discrimination apparatus shown in FIG. 1;

FIG. 3 is an exemplary vertical sectional view of the metal disk discrimination apparatus taken along the line III-III in FIG. 2;

FIG. 4 is an exemplary side view viewed from an arrow IV in FIG. 2;

FIG. 5 is an exemplary bottom view viewed from the line V-V in FIG. 2;

FIG. 6 is an exemplary circuit diagram showing an embodiment of the metal disk discrimination apparatus according to the invention;

FIG. 7 is an exemplary bottom view showing magnetic lines of flux in the bottom view of FIG. 5;

FIGS. 8A to 8C are exemplary bottom views showing shapes of end portions of leg portions of various magnetic sensors;

FIG. 9 is a graph showing an example of specific experimental data for obtaining a graph shown in FIG. 10;

FIG. 10 is an exemplary graph showing the difference between sensor outputs according to shapes of the end portions of the leg portions of the various magnetic sensors;

FIG. 11 is an exemplary bottom view like FIG. 5, showing a modification of the shape of each of the leg portions of the magnetic sensors in the metal disk discrimination apparatus according to the invention;

FIG. 12 is an exemplary bottom view like FIG. 5, showing another modification of the shape of each of the leg portions of the magnetic sensors in the metal disk discrimination apparatus according to the invention;

FIG. 13 is an exemplary bottom view like FIG. 5, showing a further modification of the shape of each of the leg portions of the magnetic sensors in the metal disk discrimination apparatus according to the invention;

FIG. 14 is an exemplary bottom view showing a relationship between an edge of a metal disk and one of the end portions of the leg portions of the magnetic sensors in the metal disk discrimination apparatus when the leg portion is shaped like a rectangle;

FIG. 15 is an exemplary vertical sectional view like FIG. 3, showing a modification of the shape of each magnetic sensor in the metal disk discrimination apparatus according to the invention; and

FIG. 16 is an exemplary vertical sectional view like FIG. 3, showing another modification of the shape of each magnetic sensor in the metal disk discrimination apparatus according to the invention.

### DETAILED DESCRIPTION OF THE EMBODIMENTS

Embodiments of a metal disk discrimination apparatus according to the invention will be described with reference to the drawings. In the embodiments, identical or like parts will be referred to by common numerals and duplicate description thereof will be omitted.

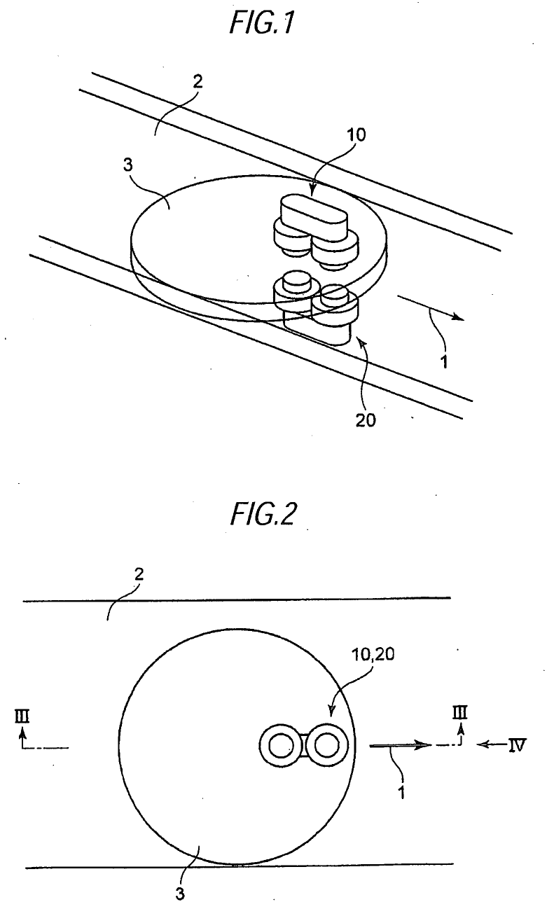

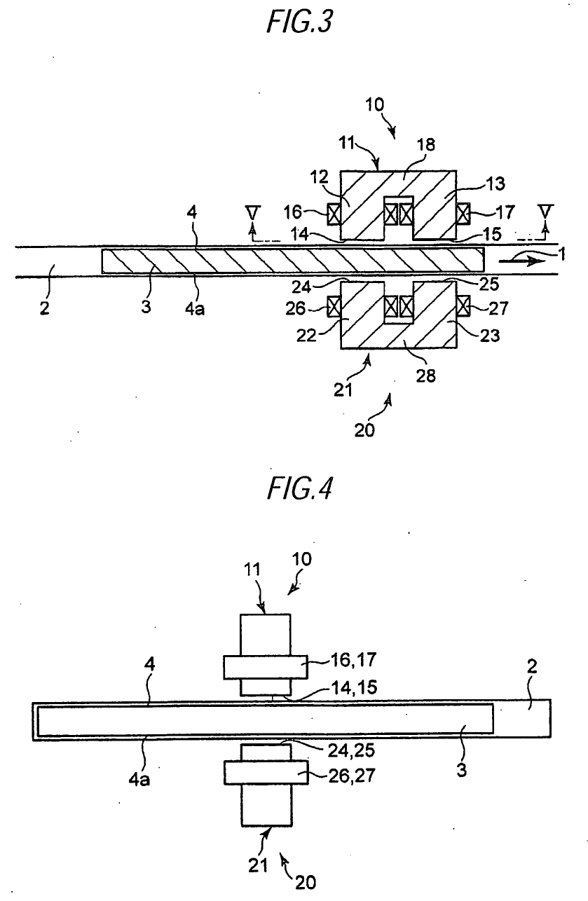

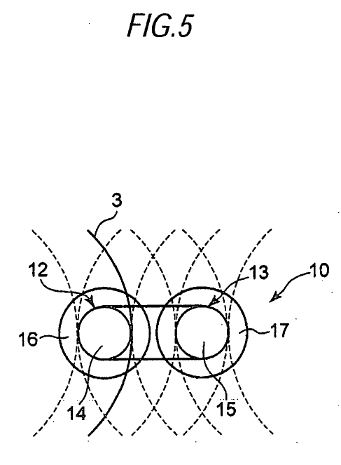

FIG. 1 is a perspective view showing an embodiment of the metal disk discrimination apparatus according to the invention. FIG. 2 is a plan view of the metal disk discrimination apparatus shown in FIG. 1. FIG. 3 is a vertical sectional view taken along the line III-III in FIG. 2. FIG. 4 is a side view from the arrow IV in FIG. 2. FIG. 5 is a bottom view from the line V-V in FIG. 3.

The metal disk discrimination apparatus according to the embodiment has a disk passageway 2, a first magnetic sensor 10, and a second magnetic sensor 20. Metal disks 3 such as coins are one by one moved straight on the disk passageway 2 in a direction 1 of movement of a surface of the disk passageway 2. The first and second magnetic sensors 10 and 20 are disposed in positions where each metal disk 3 is put between the first and second magnetic sensors 10 and 20 when the metal disk 3 passes through the disk passageway 2.

The first magnetic sensor 10 has a two-legged core 11, and coils 16 and 17. As shown in FIG. 3, the two-legged core 11 is shaped like a U figure in vertical section. The two-legged core 11 has two leg portions 12 and 13, and a connection portion 18 by which the two leg portions 12 and 13 are connected to each other. The two leg portions 12 and 13 are arranged side by side in the movement direction 1 of the metal disk 3 so that end faces 14 and 15 of the two leg portions 12 and 13 face on one disk surface 4 of the metal disk 3. The connection portion 18 connects the two leg portions 12 and 13 to each other on a side distant from the respective end faces 14 and 15 of the two leg portions 12 and 13. The leg portions 12 and 13 are wound with the coils 16 and 17 respectively. The end faces 14 and 15 of the respective leg portions 12 and 13 have magnetic polarities opposite to each other.

The second magnetic sensor 20 has the same shape and configuration as the first magnetic sensor 10. The second magnetic sensor 20 is disposed so as to be symmetrical to the first magnetic sensor 10 with respect to the surface of the disk passageway 2 through which the metal disk 3 passes. That is, the second magnetic sensor 20 has a two-legged core 21, and coils 26 and 27. The two-legged core 21 has two leg portions 22 and 23, and a connection portion 28 by which the two leg portions 22 and 23 are connected to each other. The two leg portions 22 and 23 are arranged side by side in the movement direction 1 of the metal disk 3 so that end faces 24 and 25 of the two leg portions 22 and 23 face on the other disk surface 4a of the disk metal 3 opposite to the disk surface 4. The connection portion 28 connects the two leg portions 22 and 23 to each other on a side distant from the respective end faces 24 and 25 of the two leg portions 22 and 23. The two leg portions 22 and 23 are wound with the coils 26 and 27 respectively. The end faces 24 and 25 of the two leg portions 22 and 23 have magnetic polarities opposite to each other.

The leg portions 12 and 22 of the pair of two-legged cores 11 and 21 opposite to each other with interposition of the metal disk 3 have the same magnetic polarity. The leg portions 13 and 23 of the pair of two-legged cores 11 and 21 have the same magnetic polarity.

As shown in FIG. 5, the end faces 14 and 15 of the leg portions 12 and 13 of the first magnetic sensor 10 are shaped like circles with the same diameter. The end faces 24 and 25 of the leg portions 22 and 23 of the second magnetic sensor 20 are shaped like circles with the same diameter (likewise but not shown).

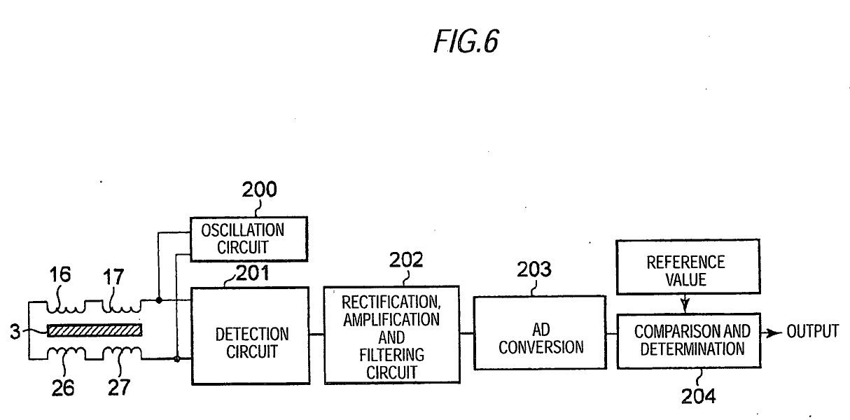

FIG. 6 is a circuit diagram showing an embodiment of the metal disk discrimination apparatus according to the invention. The coils 17, 16, 26 and 27 of the first and second magnetic sensors 10 and 20 are electrically connected in series in this order and are driven to be excited at a predetermined frequency by an oscillation circuit 200. Since the metal disk discrimination apparatus is intended to detect the surface shape of the metal disk 3 with high accuracy, it is preferable that the oscillation frequency of the oscillation circuit 200 is a frequency not allowing any electromagnetic field to permeate the metal disk 3, and more specifically, it is preferable that the oscillation frequency is not lower than 100 kHz.

When the metal disk 3 in the disk passageway 2 approaches the excited coils 16, 17, 26 and 27, an eddy current is generated inside of the metal disk 3. As a result, a demagnetizing field is emitted from the metal disk 3 to each coil to thereby disturb the magnetic field emitted from the coil, so that impedance of the coils changes to thereby cause change of electrical characteristics such as amplitude, frequency, etc. of an output voltage. For detection of this change, a detection circuit 201 detects an output waveform of the coils, and a rectification, amplification and filtering circuit 202 performs rectification, amplification and filtering on the output of the detection circuit 201. An AD conversion unit 203 converts the output of the rectification, amplification and filtering circuit 202 into a digital signal. A comparison and determination unit 204 compares the digital signal with a predetermined reference value and outputs information for discriminating between genuineness and counterfeit of metal disks and between kinds of the metal disks based on the comparison.

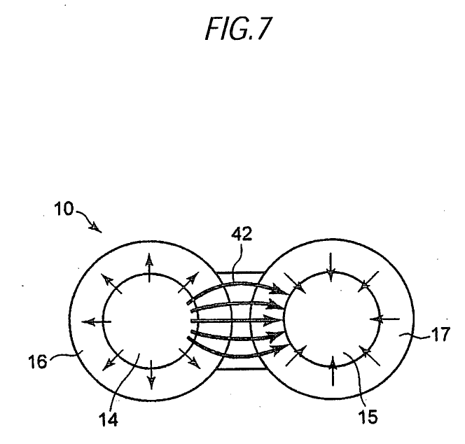

In this embodiment, as shown in FIG. 5, the end faces 14 and 15 of the leg portions 12 and 13 of the magnetic sensor 10 are shaped like circles with the same diameter which is not larger than the diameter of the smallest one of the metal disks 3 as subjects of discrimination. With this configuration, as shown in FIG. 7, magnetic flux 42 flowing between the two leg portions 12 and 13 is concentrated into a narrow range to thereby increase magnetic flux density and narrow the range of the metal disk 3 affected by the magnetic flux 42. As a result, the surface shape of the metal disk 3 can be detected in such a narrow range with high sensitivity.

In the coin discrimination apparatus disclosed in JP-B-3891101, each of the end faces of the leg portions of the magnetic sensors is shaped like a rectangle to make the magnitude of leakage magnetic flux negligible compared with the magnitude of principal magnetic flux to thereby improve sensitivity in detection of an edge shape of a metal disk. According to the method, there is a possibility of obtaining an effect in improvement of detection sensitivity of the edge shape, but the rectangular shape of each end face expands the width of magnetic flux flow. Because each magnetic sensor obtains an average in a range affected by magnetic flux as an output, expansion of the width of magnetic flux as disclosed in JP-B-3891101 means that it is impossible to obtain any output but an average in a wide range of the surface range. Accordingly, the detection sensitivity of the surface shape is lowered. Although it is desired that the surface shape of the metal disk is detected with high sensitivity in order to discriminate the metal disk, this problem can hardly be solved by the technique disclosed in JP-B-3891101.

An experimental result indicating the difference between sensor outputs in the cases where the legs of the magnetic sensors are shaped like squares, rectangles and circles will be described here.

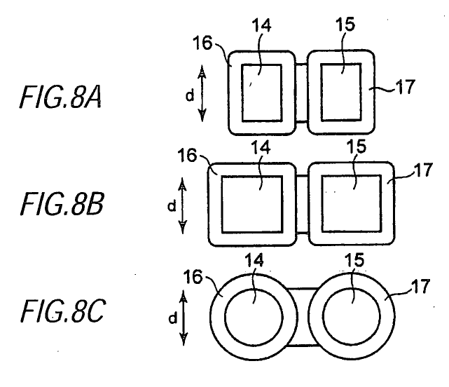

FIG. 8A shows the case where the end faces 14 and 15 of the leg portions of each magnetic sensor are shaped like rectangles. FIG. 8B shows the case where the end faces 14 and 15 are shaped like squares. FIG. 8C shows the case where the end faces 14 and 15 are shaped like circles. Incidentally, assume that a leg width d is common to the two leg portions which make a pair.

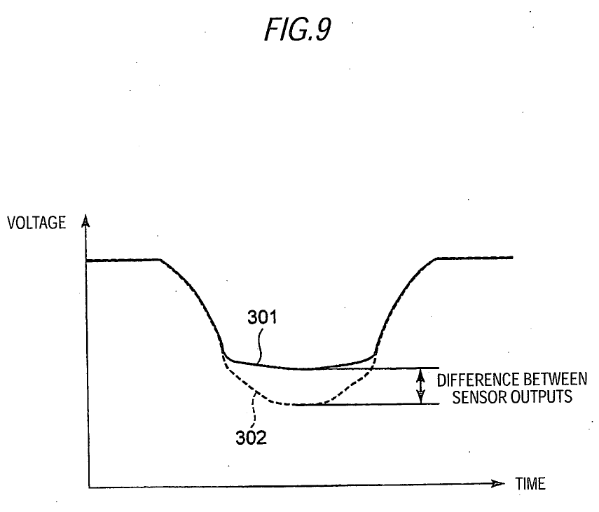

On this condition, an experiment was performed to discriminate between two kinds of metal disks (coins) 3. Assume that the two kinds of metal disks 3 are the same in material, outer shape and edge thickness but are different in surface pattern. The aforementioned two kinds of metal disks 3 are passed through the disk passageway 2 of the aforementioned metal disk discrimination apparatus. For example, as shown in FIG. 9, waveforms of sensor outputs on this occasion are expressed by different lines, e.g. a solid line 301 and a broken line 302, according to the difference between the surface patterns of the metal disks 3. This means that the sensitivity in detection of the surface shapes of the metal disks becomes higher as the difference between the sensor outputs becomes larger. On this occasion, the difference between the sensor outputs (voltages) becomes the largest when the center of each metal disk 3 passes through the center of the magnetic sensor.

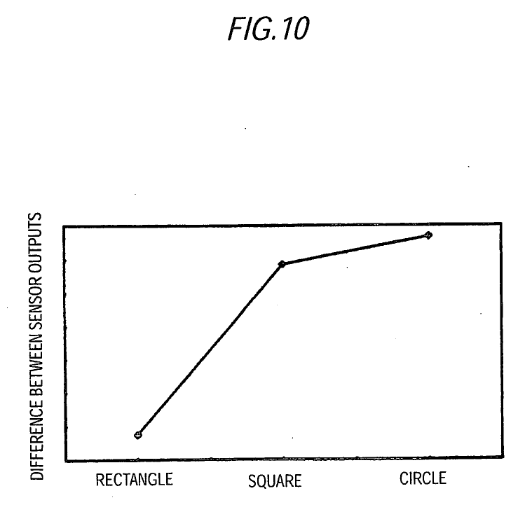

FIG. 10 shows the sensor output difference affected by the difference between the sensor shapes shown in FIGS. 8A, 8B and 8C. It is apparent from FIG. 10 that the detection sensitivity is lowered in the order of circle>square>rectangle according to the shape of each leg portion of the magnetic sensor. This is an instance showing that the circular shape improved in magnetic flux density can heighten the detection sensitivity compared with the square or rectangular shape expanded in magnetic flux width.

As is apparent from FIG. 7, such an end face shape that each of adjacent inner end faces of the two leg portions of each magnetic sensor is small in radius of curvature is preferred as the shape of each of the end faces of the leg portions of the magnetic sensors used in the metal disk discrimination apparatus according to the embodiment of the invention. Specifically, it is preferable that the radius of curvature of the adjacent inner end faces of the two leg portions of each magnetic sensor is not larger than the radius of the smallest one of the metal disks 3.

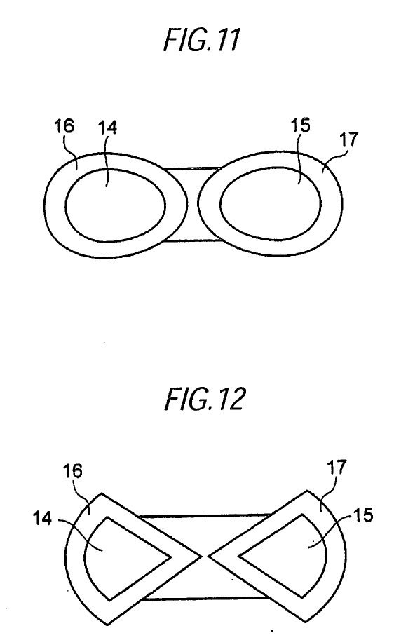

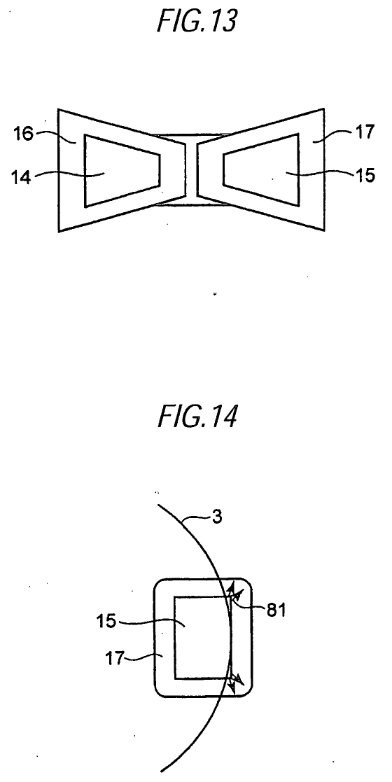

From this viewpoint, besides the circular shape, an egg shape narrowed toward each of adjacent inner sides as shown in FIG. 11, a sector shape sharpened toward each of adjacent inner sides as shown in FIG. 12, or a taper shape tapered toward each of adjacent inner sides as shown in FIG. 13 may be used as the shape of each of the end faces 14 and 15 of the leg portions of the magnetic sensor.

Next, attention will be paid to the shape of each of unadjacent outer sides of the end faces 14 and 15 of the two leg portions 12 and 13 of the magnetic sensor.

When the end faces 14 and 15 are shaped like circles with the same diameter as shown in FIG. 5 and the diameter of the circles is not larger than the diameter of the smallest one of the metal disks 3 as subjects of discrimination, large part of magnetic flux emitted from the respective end faces 14 and 15 of the legs can affect the metal disk 3 to reduce leakage magnetic flux to thereby improve the detection sensitivity of the magnetic sensor. That is, when, for example, the end faces 14 and 15 are shaped like rectangles and the outer edge of the end face 15 overlaps precisely with the outer edge of the metal disk 3 as shown in FIG. 14, corners of the end face 15 of the leg portion protrude from the metal disk 3 to thereby generate leakage magnetic flux 81 which does not affect the metal disk 3.

On the other hand, when the end face 15 of the leg portion is shaped like a circle as shown in FIG. 5 and the outer edge of the end face 15 of the leg portion overlaps precisely with the outer edge of the metal disk 3, the end face 15 of the leg portion does not protrude from the metal disk 3. For this reason, leakage magnetic flux becomes very small compared with principal magnetic flux affecting the metal disk 3 to thereby improve the detection sensitivity. From the positional relation causing this state, a detection sensitivity improving effect can be obtained particularly when the edge of the metal disk 3 is detected, so that a large effect can be obtained in addition to improvement in detection sensitivity of the surface shape.

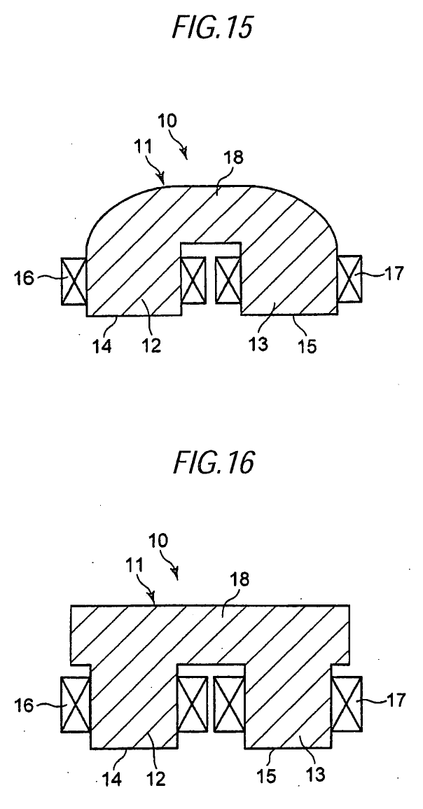

Although the embodiment has been described on the case where the two-legged core 11 is shaped like a U figure shown in FIG. 3, the two-legged core 11 may be shaped like such a U figure that the leg portions 12 and 13 are connected to each other by the connection portion 18 smoothly with a curved face as shown in FIG. 15 or may be shaped like such a H figure that the connection portion 18 protrudes from the leg portions 12 and 13 as shown in FIG. 16.

Although the embodiment has been described on the case where the metal disk 3 is moved (passed) between the magnetic sensors 10 and 20 which are fixed, any modification may be made as long as the metal disk 3 can be moved relative to the magnetic sensors 10 and 20. For example, the magnetic sensors 10 and 20 may be moved in the condition that the metal disk 3 is fixed.

What is claimed is:

1. A metal disk discrimination apparatus comprising:
two magnetic sensors configured to sandwich a target metal disk and disposed in positions symmetrical to each other with respect to the target metal disk, each of the two magnetic sensors comprising:
a two-legged core having:
two leg portions disposed opposing to a face of the target metal disk with an interval between the two leg portions along a movement direction, the movement direction in which the two magnetic sensors move relatively with respect to the target metal disk along a direction parallel to faces of the target metal disk, the two leg portions exhibiting magnetic polarities opposite to each other, each of the two leg portions having an end face facing the target metal disk, and
a connection portion disposed distant from the target metal disk and magnetically connecting the two leg portions; and
two coils respectively wound on the two leg portions;
an oscillation circuit configured to pass an alternating current through each of the two coils; and
a signal processing unit configured to determine a shape of the target metal disk by comparing an output signal of the two magnetic sensors with a reference value, the output signal corresponding to a change in impedance of the coils generated due to presence of the target metal disk; wherein:
the leg portions of one of the two magnetic sensors have same polarities as the corresponding leg portions of the other of the two magnetic sensors; and
a radius of curvature of the end face in a part adjacent to another end face is not larger than a radius of the target metal disk.

2. The metal disk discrimination apparatus of claim 1, wherein a radius of curvature of the end face in another part apart from the another end face is not larger than the radius of the target metal disk.

3. The metal disk discrimination apparatus of claim 1, wherein the end face has a circular shape.

4. The metal disk discrimination apparatus of claim 1, wherein the radius of curvature of the end face in the part adjacent to another end face is smaller than a radius of curvature of the end face in another part apart from the another end face.

5. The metal disk discrimination apparatus of claim 1, wherein:
the two coils of one of the two magnetic sensors and the two coils of the other of the two magnetic sensors are electrically connected in series; and
the signal processing unit includes:
a detection circuit that detects the signal;
a rectification, amplification and filtering circuit that rectifies, amplifies and filters an output of the detection circuit;
an analog-to-digital conversion circuit that converts an output of the rectification, amplification and filtering circuit into a digital signal; and
a comparison and determination unit that determines the shape of the target metal disk by comparing an output of the analog-to-digital conversion circuit with the reference value.
